(19) United States
(12) Patent Application Publication
(10) Pub. No.: US 2015/0189560 A1
(43) Pub. Date: Jul. 2, 2015

(54) Mobility Management Method, Base Station, and User Equipment

(71) Applicant: HUAWEI TECHNOLOGIES CO., LTD., Shenzhen (CN)

(72) Inventor: Li Ji, Shanghai (CN)

(21) Appl. No.: 14/657,968

(22) Filed: Mar. 13, 2015

Related U.S. Application Data
(63) Continuation of application No. PCT/CN2012/081413, filed on Sep. 14, 2012.

(51) Int. Cl. H04W 36/00

(52) U.S. Cl. CPC H04W 36/0088; H04W 36/0055; H04W 36/0094

(57) ABSTRACT

Embodiments of the present invention provide a mobility management method, a base station, and a user equipment. The method includes determining a first measurement configuration and a second measurement configuration. The first measurement configuration makes it more difficult than the second measurement configuration for a neighboring cell to meet a reporting criterion of a handover measurement report. The method also includes performing a measurement on a serving cell and the neighboring cell according to the first measurement configuration and performing a measurement on the serving cell and the neighboring cell according to the second measurement configuration when a reporting criterion of a handover measurement report of the first measurement configuration is not met and a timer used to detect a radio link failure starts.

This application is a continuation of International Application No. PCT/CN2012/081413, filed on Sep. 14, 2012, which is hereby incorporated by reference in its entirety.

### TECHNICAL FIELD

Embodiments of the present invention relate to the field of communications technologies, and in particular, to a mobility management method, a base station, and a user equipment.

### BACKGROUND

In a mobile communications system, in order to ensure service quality, after a UE establishes a connection to a cell, the UE still needs to measure signal quality of a serving cell and a neighboring cell, so as to select a proper cell for handing over. A cell handover procedure is that the UE measures the signal quality of the serving cell and the neighboring cell according to measurement configuration information delivered from a network side. When the signal quality that is of the neighboring cell and measured by the UE meets a handover criterion, the UE reports a measurement result to the network side. The network side determines whether to perform a handover according to the measurement result reported by the UE. However, if a parameter configuration in the handover criterion is improper, a handover cannot be performed in a timely manner, causing a radio link failure. After the radio link failure, the UE performs a radio link re-establishment attempt. A prerequisite for successful radio link re-establishment of the UE is that the UE can select a qualified cell, and the cell has a context of the UE. However, in an actual situation, there is a relatively low success rate of radio link re-establishment.

### SUMMARY

Embodiments of the present invention provide a mobility management method and a user equipment, which can effectively ensure communication continuity of a user equipment.

According to a first aspect, a mobility management method is provided, where the method includes: determining a first measurement configuration and a second measurement configuration, where the first measurement configuration makes it more difficult than the second measurement configuration for a neighboring cell to meet a reporting criterion of a handover measurement report; performing a measurement on a serving cell and the neighboring cell according to the first measurement configuration; and performing a measurement on the serving cell and the neighboring cell according to the second measurement configuration when a reporting criterion of a handover measurement report of the first measurement configuration is not met and a timer used to detect a radio link failure starts.

With reference to the first aspect, in a first possible implementation manner, specific implementation of the determining a first measurement configuration and a second measurement configuration may be receiving a configuration parameter of the first measurement configuration and a configuration parameter of the second measurement configuration that are notified by a base station.

According to the first possible implementation manner, in a second possible implementation manner, the method further includes receiving an identity that is notified by the base station and used to distinguish the configuration parameter of the first measurement configuration from the configuration parameter of the second measurement configuration.

With reference to the first aspect, in a third possible implementation manner, specific implementation of the determining a first measurement configuration and a second measurement configuration may be receiving a configuration parameter of the first measurement configuration and a scaling factor that are notified by a base station; and determining a configuration parameter of the second measurement configuration according to the configuration parameter of the first measurement configuration and the scaling factor.

With reference to the first aspect or the first possible implementation manner to the third possible implementation manner of the first aspect, in a fourth possible implementation manner.

A type of the configuration parameter of the first measurement configuration includes at least one of the following: cell individual offset CIO, a hysteresis, time to trigger TTT, and offset; or a type of the configuration parameter of the second measurement configuration includes at least one of the following: cell individual offset CIO, a hysteresis, time to trigger TTT, and offset.

With reference to the first aspect or the first possible implementation manner of the first aspect to the fourth possible implementation manner of the first aspect, in a fifth possible implementation manner, after the performing a measurement on the serving cell and the neighboring cell according to the second measurement configuration, the method further includes reporting a measurement result to a base station of the serving cell when a reporting criterion of a measurement report of the second measurement configuration is met, so that the base station of the serving cell sends a handover request message to a base station of the neighboring cell according to the measurement result.

According to the fifth possible implementation manner of the first aspect, in a sixth possible implementation manner, specific implementation may be sending a radio link re-establishment message to the base station of the neighboring cell when a radio link failure occurs.

According to a second aspect, a mobility management method is provided, where the method includes: determining a configuration parameter of a first measurement configuration and a configuration parameter of a second measurement configuration, where the first measurement configuration makes it more difficult than the second measurement configuration for a neighboring cell to meet a reporting criterion of a handover measurement report; and notifying a user equipment of the configuration parameter of the first measurement configuration and the configuration parameter of the second measurement configuration, so that the user equipment performs a measurement on a serving cell and the neighboring cell according to the first measurement configuration, and performs a measurement on the serving cell and the neighboring cell according to the second measurement configuration when a reporting criterion of a handover measurement report of the first measurement configuration is not met and a timer used to detect a radio link failure starts; or determining a configuration parameter of a first measurement configuration and a scaling factor; and notifying a user equipment of the configuration parameter of the first measurement configuration and the scaling factor, so that the user equipment determines a configuration parameter of a second measurement configuration according to the configuration parameter of the first measurement configuration and the scaling factor, where the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

With reference to the second aspect, in a first possible implementation manner, specific implementation may be as follows.

A type of the configuration parameter of the first measurement configuration includes at least one of the following: cell individual offset CIO, a hysteresis, time to trigger TTT, and offset; or a type of the configuration parameter of the second measurement configuration includes at least one of the following: cell individual offset CIO, a hysteresis, time to trigger TTT, and offset.

With reference to the second aspect or the first possible implementation manner of the second aspect, in a second possible implementation manner, specific implementation may be receiving a measurement result sent by the user equipment; and sending a handover request message to a base station of the neighboring cell according to the measurement result.

According to the second possible implementation manner of the second aspect, in a third possible implementation manner, specific implementation may be sending a handover command to the user equipment according to a handover request acknowledgment message sent by the base station of the neighboring cell.

According to a third aspect, a user equipment is provided, where the user equipment includes: a determining unit, configured to determine a first measurement configuration and a second measurement configuration, where the first measurement configuration makes it more difficult than the second measurement configuration for a neighboring cell to meet a reporting criterion of a handover measurement report; and a measurement unit, configured to perform a measurement on a serving cell and the neighboring cell according to the first measurement configuration determined by the determining unit, where when a reporting criterion of a handover measurement report of the first measurement configuration is not met and a timer used to detect a radio link failure starts, the measurement unit is further configured to perform a measurement on the serving cell and the neighboring cell according to the second measurement configuration determined by the determining unit.

With reference to the third aspect, in a first possible implementation manner, the determining unit is specifically configured to receive a configuration parameter of the first measurement configuration and a configuration parameter of the second measurement configuration that are notified by a base station.

With reference to the third aspect, in a second possible implementation manner, the determining unit is specifically configured to: receive a configuration parameter of the first measurement configuration and a scaling factor that are notified by a base station; and determine a configuration parameter of the second measurement configuration according to the configuration parameter of the first measurement configuration and the scaling factor.

With reference to the first possible implementation manner of the third aspect or the second possible implementation manner of the third aspect, in a third possible implementation manner, the determining unit is further configured to: report a measurement result to a base station of the serving cell when a reporting criterion of a measurement report of the second measurement configuration is met, so that the base station of the serving cell sends a handover request message to a base station of the neighboring cell according to the measurement result.

According to the third possible implementation manner of the third aspect, in a fourth possible implementation manner, the determining unit is further configured to: send a radio link re-establishment message to the base station of the neighboring cell when a radio link failure occurs.

According to a fourth aspect, a base station is provided, where the base station includes: a determining unit and a sending unit, where the determining unit is configured to determine a configuration parameter of a first measurement configuration and a configuration parameter of a second measurement configuration, where the first measurement configuration makes it more difficult than the second measurement configuration for a neighboring cell to meet a reporting criterion of a handover measurement report; and the sending unit is configured to notify a user equipment of the configuration parameter of the first measurement configuration and the configuration parameter of the second measurement configuration that are determined by the determining unit, so that the user equipment performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts; or the determining unit is configured to determine a configuration parameter of a first measurement configuration and a scaling factor; and the sending unit is configured to notify a user equipment of the configuration parameter of the first measurement configuration and the scaling factor that are determined by the determining unit, so that the user equipment determines a configuration parameter of a second measurement configuration according to the configuration parameter of the first measurement configuration and the scaling factor, where the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

With reference to the fourth aspect, in a first possible implementation manner, the sending unit is further configured to notify the user equipment of an identity used to distinguish the configuration parameter of the first measurement configuration from the configuration parameter of the second measurement configuration.

With reference to the fourth aspect or the first possible implementation manner of the fourth aspect, in a second possible implementation manner, the base station further includes: a receiving unit, configured to receive a measurement result sent by the user equipment; and the sending unit is further configured to: send a handover request message to a base station of the neighboring cell according to the measurement result.

According to the second possible implementation manner of the fourth aspect, in a third possible implementation manner, the sending unit is further configured to: send a handover command to the user equipment according to a handover request acknowledgment message sent by the base station of the neighboring cell.

In the embodiments of the present invention, a user equipment determines two groups of measurement configurations. When a timer used to detect a radio link failure starts, and a reporting criterion of a handover measurement report of a first measurement configuration is not met yet, the user equipment performs a measurement on a serving cell and a neighboring cell according to a second measurement configuration that has a more tolerant reporting criterion, so that the user equipment can select a proper cell in a timely manner, thereby effectively ensuring communication continuity of the user equipment.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a mobility management method according to an embodiment of the present invention;

FIG. 2a is a flowchart of a mobility management method according to another embodiment of the present invention;

FIG. 2b is a flowchart of a mobility management method according to another embodiment of the present invention;

FIG. 3 is a schematic flowchart of a process of a cell handover method according to another embodiment of the present invention;

FIG. 4 is a schematic flowchart of a process of a radio link re-establishment method according to another embodiment of the present invention;

FIG. 5 is a structural block diagram of a user equipment according to an embodiment of the present invention;

FIG. 6 is a structural block diagram of a base station according to another embodiment of the present invention;

FIG. 7 is a block diagram of a device according to an embodiment of the present invention;

FIG. 8 is a structural block diagram of a user equipment according to an embodiment of the present invention; and

FIG. 9 is a structural block diagram of a base station according to another embodiment of the present invention.

### DETAILED DESCRIPTION OF ILLUSTRATIVE EMBODIMENTS

The technical solutions of the present invention may be applied to various communications systems, such as: Global System for Mobile Communications (GSM,), Code Division Multiple Access (CDMA), Wideband Code Division Multiple Access (WCDMA), UMTS (Universal Mobile Telecommunications System), general packet radio service (GPRS), and Long Term Evolution (LTE).

A user equipment (UE), also referred to as a mobile terminal, a mobile user equipment, and the like, may communicate with one or more core networks through a radio access network (RAN). The user equipment may be a mobile terminal, such as a mobile phone (also referred to as a “cellular” phone) and a computer with a mobile terminal. For example, the user equipment may be a portable, pocket-sized, handheld, computer built-in, or in-vehicle mobile apparatus, which exchanges voice and/or data with the radio access network.

For ease of description, an LTE system is used as an example for description in the following embodiments. It should be understood that the embodiments of the present invention are not limited thereto, and the example may be another mobile communications system in addition to the LTE system.

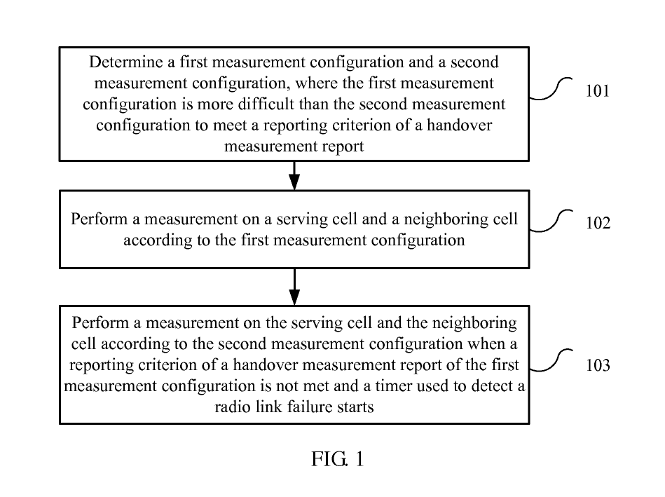

FIG. 1 is a flowchart of a mobility management method according to an embodiment of the present invention. The method in FIG. 1 is executed by a UE.

101. Determine a first measurement configuration and a second measurement configuration, where the first measurement configuration makes it more difficult than the second measurement configuration for a neighboring cell to meet a reporting criterion of a handover measurement report.

Optionally, as an embodiment, the UE may receive a configuration parameter of the first measurement configuration and a configuration parameter of the second measurement configuration that are notified by a base station. Alternatively, the UE may also receive a configuration parameter of the first measurement configuration and a scaling factor that are notified by a base station; and determine a configuration parameter of the second measurement configuration according to the configuration parameter of the first measurement configuration and the scaling factor. It should be noted that a manner of determining the first measurement configuration and the second measurement configuration by the UE is not limited in this embodiment of the present invention.

Optionally, as another embodiment, a type of the configuration parameter of the first measurement configuration may include at least one of the following: cell individual offset (CIO), a hysteresis, time to trigger (TTT), and offset; or a type of the configuration parameter of the second measurement configuration may include at least one of the following: CIO, a hysteresis, TTT, and offset.

Specifically, a base station of a serving cell may include the configuration parameter of the first measurement configuration and the configuration parameter of the second measurement configuration into a measurement control message sent to the UE. For example, if all other configured measurement parameters are unchanged; only CIO and TTT are adjusted so as to change a difficulty in meeting a handover criterion by a target cell; the CIO of the first measurement configuration is 1 dB and the TTT of the first measurement configuration is 320 ms; and the CIO of the second measurement configuration is 3 dB and the TTT of the second measurement configuration is 320 ms, the first measurement configuration makes it more difficult than the second measurement configuration for the neighboring cell to meet the reporting criterion of a handover measurement report because the CIO of the first measurement configuration is less than the CIO of the second measurement configuration. For another example, the CIO of the first measurement configuration is 1 dB and the TTT of the first measurement configuration is 320 ms; and the CIO of the second measurement configuration is 1 dB and the TTT of the second measurement configuration is 160 ms. Although the CIO of the first measurement configuration is the same as the CIO of the second measurement configuration, the TTT of the first measurement configuration is longer than the TTT of the second measurement configuration. Therefore, the first measurement configuration makes it more difficult than the second measurement configuration for the neighboring cell to meet the reporting criterion of a handover measurement report. For still another example, the CIO of the first measurement configuration is 1 dB and the TTT of the first measurement configuration is 320 ms; and the CIO of the second measurement configuration is 2 dB and the TTT of the second measurement configuration is 180 ms. The CIO of the second measurement configuration is greater than the CIO of the first measurement configuration, and the TTT of the second measurement configuration is shorter than the TTT of the first measurement configuration. Therefore, the first measurement configuration makes it more difficult than the second measurement configuration for the neighboring cell to meet the reporting criterion of a handover measurement report. It should be understood that the selection of the foregoing configuration parameters and the values of the configuration parameters are merely exemplary, and are merely intended to help a person skilled in the art to more easily understand the present invention but not intended to limit the present invention.

The base station of the serving cell may include the configuration parameter of the first measurement configuration and the scaling factor into the measurement control message sent to the UE, and the UE may determine the configuration parameter of the second measurement configuration according to the configuration parameter of the first measurement configuration and the scaling factor. For example, the TTT of the first measurement configuration is 320 ms, and the scaling factor is 0.5; and the UE may determine that the TTT of the second measurement configuration is 320 ms*0.5, that is, 160 ms. Alternatively, the CIO of the first measurement configuration is 1 dB, and the scaling factor is 3; and the UE may determine that the CIO of the second measurement configuration is 1 dB*3, that is, 3 dB. Therefore, the first measurement configuration makes it more difficult than the second measurement configuration for the neighboring cell to meet the reporting criterion of a handover measurement report. It should be understood that the selection of the foregoing configuration parameters and the values of the scaling factor are merely exemplary, and are merely intended to help a person skilled in the art to more easily understand the present invention but not intended to limit the present invention.

Further, the UE may receive an identity that is notified by the base station and used to distinguish the configuration parameter of the first measurement configuration from the configuration parameter of the second measurement configuration. For example, 0 identifies the first measurement configuration, and 1 identifies the second measurement configuration. Alternatively, the UE may distinguish the first measurement configuration from the second measurement configuration according to a measurement identity (MeasID). Alternatively, the UE may also pre-negotiate with the base station about that a measurement configuration received on which resource is the first measurement configuration or the second measurement configuration, and the like.

It should be understood that the selection and the values of the foregoing configuration parameters and the values of the scaling factor are merely exemplary but not intended to limit the present invention. It should further be understood that a manner of notifying the UE by the base station and a manner of distinguishing between two groups of measurement configurations by the UE are not limited in this embodiment of the present invention.

102. Perform a measurement on a serving cell and the neighboring cell according to the first measurement configuration.

103. Perform a measurement on the serving cell and the neighboring cell according to the second measurement configuration when a reporting criterion of a handover measurement report of the first measurement configuration is not met and a timer used to detect a radio link failure starts.

Optionally, as another embodiment, the base station may deliver indication information to the UE before step 102, where the indication information is used to indicate that the first measurement configuration is used before the timer starts, and the second measurement configuration is used after the timer starts.

Optionally, as another embodiment, the UE performs a measurement on the serving cell and the neighboring cell, where a measurement value may be RSRP (reference signal received power), RSRQ (reference signal received quality), or the like of LTE; may be RSCP (received signal code power) or Ec/No of UMTS; or may also be Rxlev (received signal level), Rxqual (received signal quality), or the like of GSM. It should be understood that this embodiment of the present invention is not limited thereto.

Optionally, as another embodiment, failing to meet the reporting criterion of a handover measurement report of the first measurement configuration may be failing to meet an event threshold or a time threshold in the first measurement configuration. For example, a measurement value of the neighboring cell does not meet the event threshold, a difference between the measurement value of the neighboring cell and a measurement value of the serving cell does not meet the event threshold, or the measurement value of the neighboring cell meets the event threshold but does not meet the time threshold, that is, duration meeting the event threshold does not exceed the time threshold and the like. It should be understood that this embodiment of the present invention does not constitute a limitation on whether the serving cell and the neighboring cell are intra-frequency cells, inter-frequency cells, or inter-system cells.

Optionally, as another embodiment, the timer used to detect a radio link failure may be T310 in LTE, where for details, reference may be made to 3GPP Technical Specification 36.331; may be T313 in UMTS, where for details, reference may be made to 3GPP Technical Specification 25.331; or the like. It should be understood that this embodiment of the present invention is not limited thereto.

For example, an LTE system is used as an example for description. The UE performs a measurement on the serving cell and the neighboring cell according to the first measurement configuration; however, the measurement value of the neighboring cell does not meet the reporting criterion of a handover measurement report of the first measurement configuration. If the UE receives N310 out-of-sync indications at an RRC (radio resource control) layer, and timer T310 starts, the UE may perform a measurement on the serving cell and the neighboring cell according to the second measurement configuration, and for details, reference may be made to 3GPP Technical Specification 36.331.

In this embodiment of the present invention, a user equipment determines two groups of measurement configurations. When a timer used to detect a radio link failure starts, and a reporting criterion of a handover measurement report of a first measurement configuration is not met yet, the user equipment performs a measurement on a serving cell and a neighboring cell according to a second measurement configuration that has a more tolerant reporting criterion, so that the user equipment can select a proper cell in a timely manner, thereby effectively ensuring communication continuity of the user equipment.

In addition, after step 103, when the measurement value of the neighboring cell meets a reporting criterion of a measurement report of the second measurement configuration, a measurement result may be reported to the base station of the serving cell, so that the base station of the serving cell may send a handover request message to a base station of the neighboring cell. Further, the base station of the serving cell receives a handover request acknowledgment message sent by the base station of the neighboring cell.

Optionally, in an implementation manner, the base station performs a cell handover for the UE, so that the UE can be handed over to a cell of better signal quality in a timely manner, thereby effectively increasing a handover success rate and ensuring communication continuity of the UE.

In another implementation manner, an LTE system is used as an example; when a radio link failure occurs on the UE, and if T310 expires, the UE may send a radio link re-establishment message to the base station of the neighboring cell, that is, initiate an RRC connection re-establishment procedure. The base station of the neighboring cell has a context of the UE, and therefore a success rate of radio link re-establishment is increased, so that the UE can be handed over to a cell of better signal quality in a timely manner, thereby ensuring communication continuity of the UE.

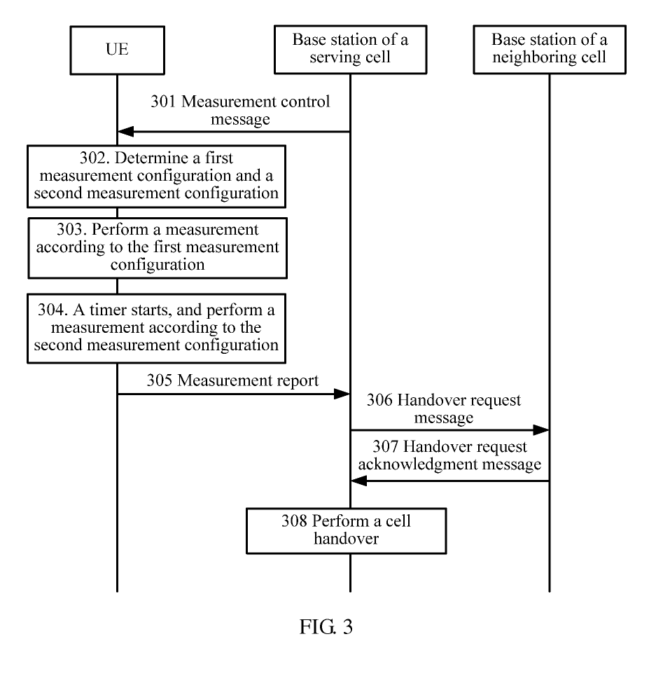

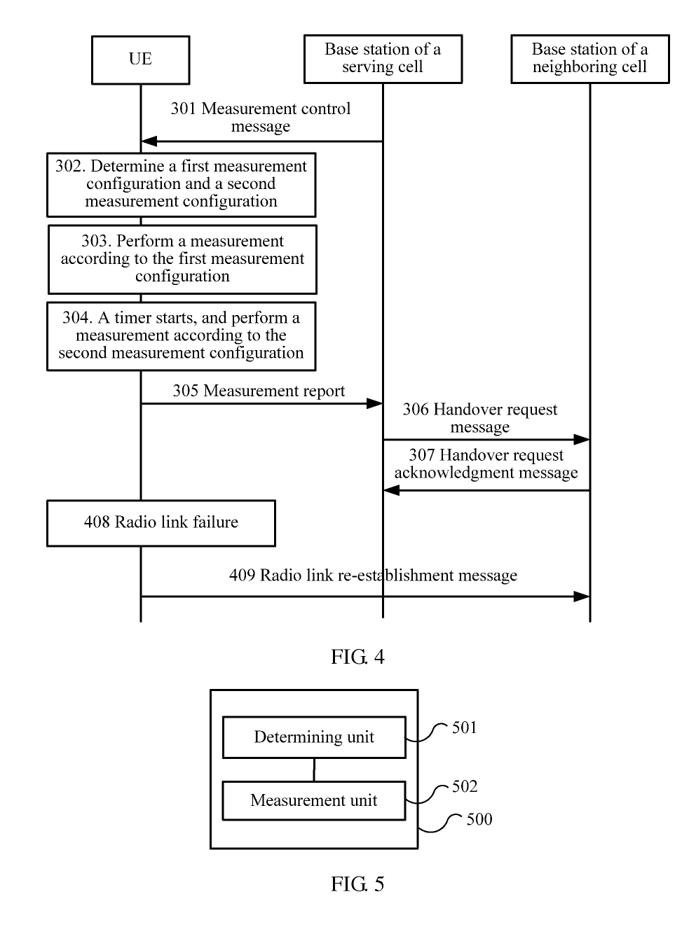

Nonrestrictive implementation manners of a cell handover and radio link re-establishment are further described in the following with reference to examples in FIG. 3 and FIG. 4.

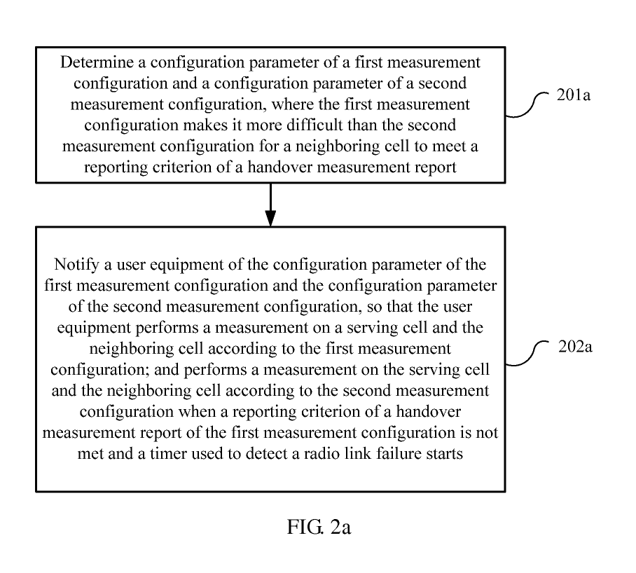

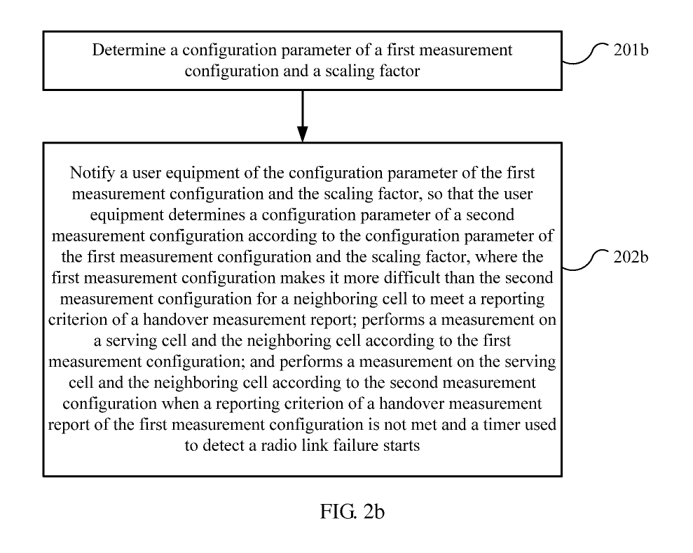

FIG. 2a is a flowchart of a mobility management method according to another embodiment of the present invention. The method in FIG. 2a is executed by a base station and is corresponding to the method in FIG. 1. Therefore, descriptions that have been provided in the embodiment in FIG. 1 are appropriately omitted.

201a. Determine a configuration parameter of a first measurement configuration and a configuration parameter of a second measurement configuration, where the first measurement configuration makes it more difficult than the second measurement configuration for a neighboring cell to meet a reporting criterion of a handover measurement report.

202a. Notify a user equipment of the configuration parameter of the first measurement configuration and the configuration parameter of the second measurement configuration, so that the user equipment performs a measurement on a serving cell and the neighboring cell according to the first measurement configuration, and performs a measurement on the serving cell and the neighboring cell according to the second measurement configuration when a reporting criterion of a handover measurement report of the first measurement configuration is not met and a timer used to detect a radio link failure starts.

FIG. 2b is a flowchart of a mobility management method according to another embodiment of the present invention. The method in FIG. 2b is executed by a base station and is corresponding to the method in FIG. 1. Therefore, descriptions that have been provided in the embodiment in FIG. 1 are appropriately omitted.

201b. Determine a configuration parameter of a first measurement configuration and a scaling factor.

202b. Notify a user equipment of the configuration parameter of the first measurement configuration and the scaling factor, so that the user equipment determines a configuration parameter of a second measurement configuration according to the configuration parameter of the first measurement configuration and the scaling factor, where the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

Optionally, in step 202a, as an embodiment, the base station may notify the user equipment of an identity used to distinguish the configuration parameter of the first measurement configuration from the configuration parameter of the second measurement configuration. Alternatively, the base station may send the first measurement configuration or the second measurement configuration by using a corresponding resource pre-negotiated by the base station and the UE, so that the UE can distinguish between these two groups of measurement configurations.

Optionally, in the method in FIG. 2a or FIG. 2b, as another embodiment, a type of the configuration parameter of the first measurement configuration may include at least one of the following: CIO, a hysteresis, TTT, and offset; or a type of the configuration parameter of the second measurement configuration may include at least one of the following: CIO, a hysteresis, TTT, and offset.

Specifically, a base station of the serving cell may include the configuration parameter of the first measurement configuration and the configuration parameter of the second measurement configuration into a measurement control message sent to the UE. For example, the CIO of the first measurement configuration is 1 dB and the TTT of the first measurement configuration is 320 ms; and the CIO of the second measurement configuration is 3 dB and the TTT of the second measurement configuration is 320 ms. Because the CIO of the second measurement configuration is greater than the CIO of the first measurement configuration, the first measurement configuration makes it more difficult than the second measurement configuration for the neighboring cell to meet the reporting criterion of a handover measurement report. For another example, the CIO of the first measurement configuration is 1 dB and the TTT of the first measurement configuration is 320 ms; and the CIO of the second measurement configuration is 1 dB and the TTT of the second measurement configuration is 160 ms. Although the CIO of the first measurement configuration is the same as the CIO of the second measurement configuration, the TTT of the second measurement configuration is shorter than the TTT of the first measurement configuration. Therefore, the first measurement configuration makes it more difficult than the second measurement configuration for the neighboring cell to meet the reporting criterion of a handover measurement report. For still another example, the CIO of the first measurement configuration is 1 dB and the TTT of the first measurement configuration is 320 ms; and the CIO of the second measurement configuration is 2 dB and the TTT of the second measurement configuration is 180 ms. The CIO of the second measurement configuration is greater than the CIO of the first measurement configuration, and the TTT of the second measurement configuration is shorter than the TTT of the first measurement configuration. Therefore, the first measurement configuration makes it more difficult than the second measurement configuration for the neighboring cell to meet the reporting criterion of a handover measurement report. It should be understood that the selection of the foregoing configuration parameters and the values of the configuration parameters are merely exemplary, and are merely intended to help a person skilled in the art to more easily understand the present invention but not intended to limit the present invention.

The base station of the serving cell may include the configuration parameter of the first measurement configuration and the scaling factor into the measurement control message sent to the UE, and the UE may determine the configuration parameter of the second measurement configuration according to the configuration parameter of the first measurement configuration and the scaling factor. For example, the TTT of the first measurement configuration is 320 ms, and the scaling factor is 0.5; and the UE may determine that the TTT of the second measurement configuration is 320 ms*0.5, that is, 160 ms. Alternatively, the CIO of the first measurement configuration is 1 dB, and the scaling factor is 3; and the UE may determine that the CIO of the second measurement configuration is 1 dB*3, that is, 3 dB. Therefore, the first measurement configuration makes it more difficult than the second measurement configuration for the neighboring cell to meet the reporting criterion of a handover measurement report. It should be understood that the selection of the foregoing configuration parameters and the values of the scaling factor are merely exemplary, and are merely intended to help a person skilled in the art to more easily understand the present invention but not intended to limit the present invention.

It should further be understood that a manner of notifying the UE by the base station is not limited in this embodiment of the present invention.

Optionally, after step 201b or step 202b, as another embodiment, the base station may receive a measurement result sent by the UE, and send a handover request message to a base station of the neighboring cell according to the measurement result. Further, the base station of the serving cell receives a handover request acknowledgment message sent by the base station of the neighboring cell.

In an implementation manner, the base station performs a cell handover for the UE, so that the UE can be handed over to a cell of better signal quality in a timely manner, thereby effectively increasing a handover success rate and ensuring communication continuity of the UE.

In another implementation manner, the base station sends a handover request message to the base station of the neighboring cell, where the base station of the neighboring cell has a context of the UE. Therefore, the UE sends a radio link re-establishment message to the base station of the neighboring cell when a radio link failure occurs on the UE, that is, when the UE initiates an RRC connection re-establishment procedure, because the base station of the neighboring cell has the context of the UE, a success rate of radio link re-establishment is increased, so that the UE can be handed over to a cell of better signal quality in a timely manner, thereby ensuring communication continuity of the UE.

In this embodiment of the present invention, a base station not only notifies a user equipment of a configuration parameter of a first measurement configuration but also notifies the user equipment of a configuration parameter of a second measurement configuration or a scaling factor. The user equipment may determine the configuration parameter of the second measurement configuration by using the scaling factor. Therefore, when a timer used to detect a radio link failure starts, and a reporting criterion of a handover measurement report of the first measurement configuration is not met, the user equipment performs a measurement on a serving cell and a neighboring cell according to the second measurement configuration that has a more tolerant reporting criterion, so that the user equipment can select a proper cell in a timely manner, thereby effectively ensuring communication continuity of the user equipment.

Nonrestrictive implementation manners of a cell handover and radio link re-establishment are described in the following with reference to examples in FIG. 3 and FIG. 4. For ease of description, an LTE system is used as an example for description in the following embodiments. It should be understood that the embodiments of the present invention are not limited thereto, and the example may be another mobile communications system in addition to the LTE system.

FIG. 3 is a schematic flowchart of a process of a cell handover method according to another embodiment of the present invention.

301. A base station of a serving cell sends a measurement control message to a UE.

For example, the base station may include a configuration parameter of a first measurement configuration and a configuration parameter of a second measurement configuration into the measurement control message sent to the UE; or the base station may include a configuration parameter of a first measurement configuration and a scaling factor into the measurement control message sent to the UE. Optionally, the configuration parameter may be at least one of the following: CIO, a hysteresis, TTT, offset, and the like.

Specifically, CIO of the first measurement configuration is 1 dB and TTT of the first measurement configuration is 320 ms; and CIO of the second measurement configuration is 3 dB and TTT of the second measurement configuration is 160 ms. Alternatively, TTT of the first measurement configuration is 320 ms, and the scaling factor is 0.5.

302. The UE determines a first measurement configuration and a second measurement configuration.

For example, the UE may determine the configuration parameter of the second measurement configuration according to the configuration parameter of the first measurement configuration and the scaling factor that are received in step 301. Specifically, the TTT of the first measurement configuration is 320 ms and the scaling factor is 0.5; the UE may determine that the TTT of the second measurement configuration is 320 ms*0.5, that is, 160 ms. Alternatively, the CIO of the first measurement configuration is 1 dB and the scaling factor is 3; the UE may determine that the CIO of the second measurement configuration is 1 dB*3, that is, 3 dB.

It should be noted that a manner of determining the first measurement configuration and the second measurement configuration by the UE is not limited in this embodiment of the present invention. It should further be understood that the selection and the values of the foregoing configuration parameters and the values of the scaling factor are merely exemplary but not intended to limit the present invention. It should further be understood that a manner of notifying the UE by the base station is not limited in this embodiment of the present invention.

303. The UE performs a measurement according to the first measurement configuration.

304. When a timer used to detect a radio link failure starts, the UE performs a measurement on a serving cell and a neighboring cell.

For example, the UE performs a measurement on the serving cell and the neighboring cell according to the first measurement configuration; however, a measurement value of the neighboring cell does not meet a reporting criterion of a handover measurement report of the first measurement configuration. If the UE receives N310 out-of-sync indications at an RRC layer, and timer T310 starts, the UE may perform a measurement on the serving cell and the neighboring cell according to the second measurement configuration.

The measurement value may be RSRP, RSRQ, or the like of LTE. It should be understood that this embodiment of the present invention is not limited thereto. The measurement value may further be RSCP or Ec/No of UMTS or may further be Rxlev, Rxqual, or the like of GSM.

Failing to meet the reporting criterion of a handover measurement report of the first measurement configuration may be failing to meet an event threshold or a time threshold in the first measurement configuration. For example, the measurement value of the neighboring cell does not meet the event threshold, a difference between the measurement value of the neighboring cell and a measurement value of the serving cell does not meet the event threshold, or the measurement value of the neighboring cell meets the event threshold but does not meet the time threshold, that is, duration meeting the event threshold does not exceed the time threshold and the like. It should be understood that this embodiment of the present invention does not constitute a limitation on whether the serving cell and the neighboring cell are intra-frequency cells, inter-frequency cells, or inter-system cells.

Optionally, the base station may deliver indication information to the UE before step 303, where the indication information is used to indicate that the first measurement configuration is used before the timer starts, and the second measurement configuration is used after the timer starts.

305. The UE sends a measurement report to a base station of the serving cell.

306. The base station of the serving cell sends a handover request message to a base station of the neighboring cell.

307. The base station of the neighboring cell sends a handover request acknowledgment message to the base station of the serving cell.

308. The base station of the serving cell performs a cell handover for the UE.

For example, when the measurement value of the neighboring cell meets a reporting criterion of a measurement report of the second measurement configuration, the UE may report a measurement result to the base station of the serving cell. The base station of the serving cell may send a handover request message to the base station of the neighboring cell according to the measurement result. Further, the base station of the serving cell receives a handover request acknowledgment message sent by the base station of the neighboring cell and performs a cell handover for the UE, so that the UE can be handed over to a cell of better signal quality in a timely manner, and a handover success rate can be effectively increased, thereby ensuring communication continuity of the UE.

FIG. 4 is a schematic flowchart of a process of a radio link re-establishment method according to another embodiment of the present invention. In the schematic flowchart shown in FIG. 4, steps same as or similar to those in FIG. 3 use same reference numerals. To avoid repetition, details are not provided herein again.

408. A radio link failure occurs on the UE.

409. The UE sends a radio link re-establishment message to the base station of the neighboring cell.

For example, an LTE system is used as an example; when a radio link failure occurs on the UE, and if T310 expires, the UE may send a radio link re-establishment message to the base station of the neighboring cell, that is, initiate an RRC connection re-establishment procedure. The base station of the neighboring cell has a context of the UE, and therefore a success rate of radio link re-establishment is increased, so that the UE can be handed over to a cell of better signal quality in a timely manner, thereby ensuring communication continuity of the UE.

FIG. 5 is a structural block diagram of a user equipment according to an embodiment of the present invention. A user equipment 500 in FIG. 5 includes a determining unit 501 and a measurement unit 502.

The determining unit 501 is configured to determine a first measurement configuration and a second measurement configuration, where the first measurement configuration makes it more difficult than the second measurement configuration for a neighboring cell to meet a reporting criterion of a handover measurement report. The measurement unit 502 is configured to perform a measurement on a serving cell and the neighboring cell according to the first measurement configuration determined by the determining unit 501, where when a reporting criterion of a handover measurement report of the first measurement configuration is not met and a timer used to detect a radio link failure starts, the measurement unit 502 is further configured to perform a measurement on the serving cell and the neighboring cell according to the second measurement configuration determined by the determining unit 501.

In this embodiment of the present invention, a user equipment determines two groups of measurement configurations. When a timer used to detect a radio link failure starts, and a reporting criterion of a handover measurement report of a first measurement configuration is not met yet, the user equipment performs a measurement on a serving cell and a neighboring cell according to a second measurement configuration that has a more tolerant reporting criterion, so that the user equipment can select a proper cell in a timely manner, thereby effectively ensuring communication continuity of the user equipment.

The user equipment 500 can implement steps that are related to the user equipments mentioned in the methods in FIG. 1 to FIG. 4. To avoid repetition, details are not provided herein again.

Optionally, as an embodiment, the determining unit 501 is specifically configured to receive a configuration parameter of the first measurement configuration and a configuration parameter of the second measurement configuration that are notified by a base station. Further, the determining unit 501 is specifically configured to: receive an identity that is notified by the base station and used to distinguish the configuration parameter of the first measurement configuration from the configuration parameter of the second measurement configuration.

Optionally, as another embodiment, the determining unit 501 is specifically configured to receive a configuration parameter of the first measurement configuration and a scaling factor that are notified by a base station; and determine a configuration parameter of the second measurement configuration according to the configuration parameter of the first measurement configuration and the scaling factor.

Optionally, as another embodiment, the determining unit 501 is further configured to report a measurement result to a base station of the serving cell when a reporting criterion of a measurement report of the second measurement configuration is met, so that the base station of the serving cell sends a handover request message to a base station of the neighboring cell. Further, the determining unit 501 is further configured to send a radio link re-establishment message to the base station of the neighboring cell when a radio link failure occurs.

Therefore, a success rate of a cell handover or radio link re-establishment is increased, so that a UE can be handed over to a cell of better signal quality in a timely manner, thereby ensuring communication continuity of the UE.

FIG. 6 is a structural block diagram of a base station according to another embodiment of the present invention. A base station 600 in FIG. 6 includes a determining unit 601 and a sending unit 602.

The determining unit 601 is configured to determine a configuration parameter of a first measurement configuration and a configuration parameter of a second measurement configuration, where the first measurement configuration makes it more difficult than the second measurement configuration for a neighboring cell to meet a reporting criterion of a handover measurement report. The sending unit 602 is configured to notify a user equipment of the configuration parameter of the first measurement configuration and the configuration parameter of the second measurement configuration that are determined by the determining unit 601, so that the user equipment performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

Alternatively, the determining unit 601 is configured to determine a configuration parameter of a first measurement configuration and a scaling factor. The sending unit 602 is configured to notify a user equipment of the configuration parameter of the first measurement configuration and the scaling factor that are determined by the determining unit 601, so that the user equipment determines a configuration parameter of a second measurement configuration according to the configuration parameter of the first measurement configuration and the scaling factor, where the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

In this embodiment of the present invention, a base station not only notifies a user equipment of a configuration parameter of a first measurement configuration but also notifies the user equipment of a configuration parameter of a second measurement configuration or a scaling factor. The user equipment may determine the configuration parameter of the second measurement configuration by using the scaling factor. Therefore, when a timer used to detect a radio link failure starts, and a reporting criterion of a handover measurement report of the first measurement configuration is not met, the user equipment performs a measurement on a serving cell and a neighboring cell according to the second measurement configuration that has a more tolerant reporting criterion, so that the user equipment can select a proper cell in a timely manner, thereby effectively ensuring communication continuity of the user equipment.

The base station 600 can implement steps of the base stations mentioned in the methods in FIG. 1 to FIG. 4. To avoid repetition, details are not provided herein again.

Optionally, as an embodiment, the sending unit 602 is further configured to: notify the user equipment of an identity used to distinguish the configuration parameter of the first measurement configuration from the configuration parameter of the second measurement configuration.

Optionally, as another embodiment, the base station 600 further includes a receiving unit 603, where the receiving unit 603 is configured to receive a measurement result sent by the user equipment. The sending unit 602 is further configured to send a handover request message to a base station of the neighboring cell according to the measurement result. Further, the sending unit 602 is further configured to send a handover command to the user equipment according to a handover request acknowledgment message sent by the base station of the neighboring cell.

Therefore, a success rate of a cell handover or radio link re-establishment is increased, so that a UE can be handed over to a cell of better signal quality in a timely manner, thereby ensuring communication continuity of the UE.

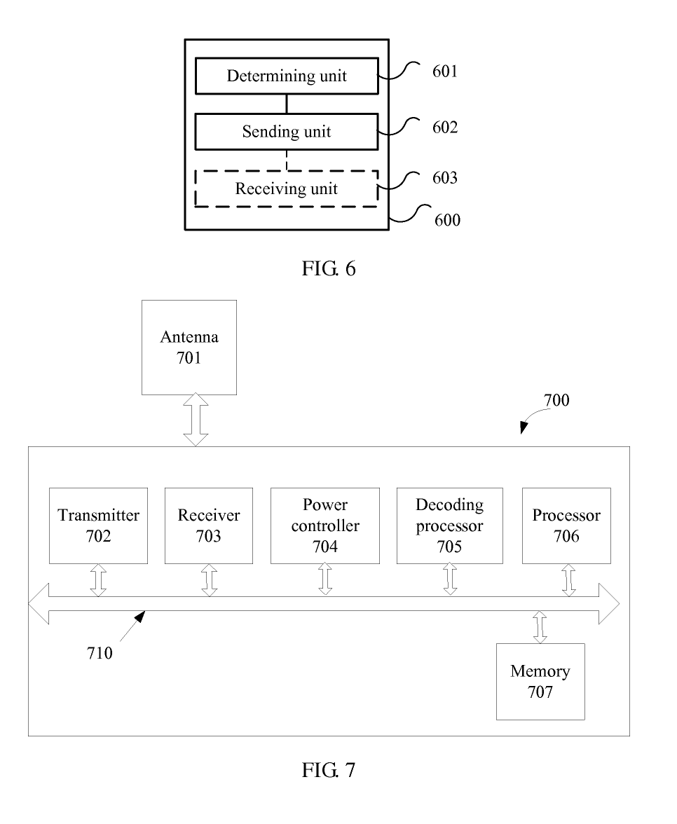

An embodiment of the present invention further provides an apparatus embodiment that implements the steps and the methods in the foregoing method embodiments. This embodiment of the present invention may be applied to base stations and user equipments in various communications systems. FIG. 7 shows an embodiment of a device. In this embodiment, a device 700 includes a transmitter 702, a receiver 703, a power controller 704, a decoding processor 705, a processor 706, a memory 707, and an antenna 701. The processor 706 controls an operation of the device 700, and the processor 706 may also be referred to as a central processing unit CPU. The memory 707 may include a read-only memory and a random access memory, and provides an instruction and data to the processor 706. A part of the memory 707 may further include a non-volatile random access memory (NVRAM). In a specific application, the device 700 may be built in or may be a wireless communications device itself, such as a mobile phone; and may further include a carrier that accommodates the transmitter 702 and the receiver 703, so as to allow data transmission and reception between the device 700 and a remote location. The transmitter 702 and the receiver 703 may be coupled to the antenna 701. All components of the device 700 are coupled together by using a bus system 710, where the bus system 710 may include a power bus, a control bus, and a status signal bus in addition to a data bus. However, for clarity of description, various buses are marked as the bus system 710 in the figure. The device 700 may further include the processor 706 configured to process a signal, and in addition, further includes the power controller 704 and the decoding processor 705.

The methods disclosed in the foregoing embodiments of the present invention may be applied to the foregoing device 700 or are mainly implemented by using the processor 706 and the transmitter 702 in the device 700. The processor 706 may be an integrated circuit chip and exhibits signal processing capabilities. In an implementation process, the steps in the foregoing methods may be completed by means of an integrated logic circuit of hardware in the processor 706 or an instruction in a form of software. The foregoing decoding processor configured to execute the methods disclosed in the embodiments of the present invention may be a general purpose processor, a digital signal processor (DSP), an application-specific integrated circuit (ASIC), a field programmable gate array (FPGA) or another programmable logic component, a discrete gate or a transistor logic component, or a discrete hardware assembly. The decoding processor may implement or execute the methods, steps and logical block diagrams disclosed in the embodiments of the present invention. The general purpose processor may be a microprocessor or the processor may also be any conventional processor, decoder, or the like. Steps of the methods disclosed with reference to the embodiments of the present invention may be directly executed and completed by means of a hardware decoding processor, or may be executed and completed by using a combination of hardware and software modules in the decoding processor. The software module may be located in a mature storage medium in the field, such as a random access memory, a flash memory, a read-only memory, a programmable read-only memory, an electrically-erasable programmable memory, or a register. The storage medium is located in the memory 707. The decoding processor reads information in the memory 707, and completes the steps of the foregoing methods in combination with hardware.

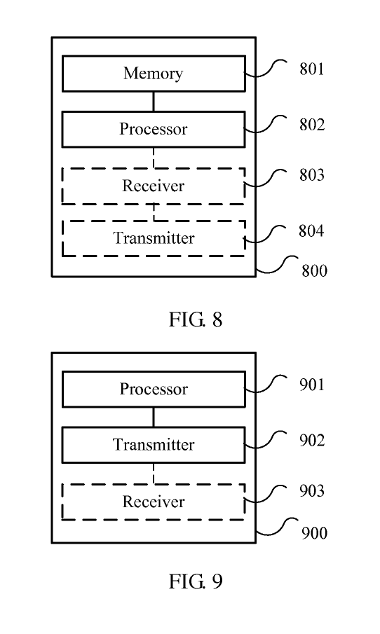

Further, FIG. 8 is a structural block diagram of a user equipment according to an embodiment of the present invention. A user equipment 800 in FIG. 8 includes a memory 801 and a processor 802.

The processor 802 is configured to determine a first measurement configuration and a second measurement configuration, where the first measurement configuration makes it more difficult than the second measurement configuration for a neighboring cell to meet a reporting criterion of a handover measurement report.

The processor 802 is further configured to perform a measurement on a serving cell and the neighboring cell according to the first measurement configuration stored in the memory 801, where when a reporting criterion of a handover measurement report of the first measurement configuration is not met and a timer used to detect a radio link failure starts, the processor 802 is further configured to perform a measurement on the serving cell and the neighboring cell according to the second measurement configuration stored in the memory 801.

In this embodiment of the present invention, a user equipment determines two groups of measurement configurations. When a timer used to detect a radio link failure starts, and a reporting criterion of a handover measurement report of a first measurement configuration is not met yet, the user equipment performs a measurement on a serving cell and a neighboring cell according to a second measurement configuration that has a more tolerant reporting criterion, so that the user equipment can select a proper cell in a timely manner, thereby effectively ensuring communication continuity of the user equipment.

The user equipment 800 can implement steps that are related to the user equipments mentioned in the methods in FIG. 1 to FIG. 4. To avoid repetition, details are not provided herein again.

Optionally, as an embodiment, the user equipment 800 further includes a receiver 803, where the receiver 803 is configured to receive a configuration parameter of the first measurement configuration and a configuration parameter of the second measurement configuration that are notified by a base station. Further, the receiver 803 is specifically configured to receive an identity that is notified by the base station and used to distinguish the configuration parameter of the first measurement configuration from the configuration parameter of the second measurement configuration.

Optionally, as another embodiment, the receiver 803 is configured to receive a configuration parameter of the first measurement configuration and a scaling factor that are notified by a base station; and the processor 802 determines a configuration parameter of the second measurement configuration according to the configuration parameter of the first measurement configuration and the scaling factor that are received by the receiver 803.

Optionally, as another embodiment, the user equipment 800 further includes a transmitter 804, where the transmitter 804 is configured to report a measurement result to a base station of the serving cell when a reporting criterion of a measurement report of the second measurement configuration is met, so that the base station of the serving cell sends a handover request message to a base station of the neighboring cell. Further, the transmitter 804 is further configured to send a radio link re-establishment message to the base station of the neighboring cell when a radio link failure occurs.

Therefore, a success rate of a cell handover or radio link re-establishment is increased, so that a UE can be handed over to a cell of better signal quality in a timely manner, thereby ensuring communication continuity of the UE.

FIG. 9 is a structural block diagram of a base station according to another embodiment of the present invention. A base station 900 in FIG. 9 includes a processor 901 and a transmitter 902.

The processor 901 is configured to determine a configuration parameter of a first measurement configuration and a configuration parameter of a second measurement configuration, where the first measurement configuration makes it more difficult than the second measurement configuration for a neighboring cell to meet a reporting criterion of a handover measurement report. The transmitter 902 is configured to notify a user equipment of the configuration parameter of the first measurement configuration and the configuration parameter of the second measurement configuration that are determined by the processor 901, so that the user equipment performs a measurement on a serving cell and the neighboring cell according to the first measurement configuration, and performs a measurement on the serving cell and the neighboring cell according to the second measurement configuration when a reporting criterion of a handover measurement report of the first measurement configuration is not met and a timer used to detect a radio link failure starts.

Alternatively, the processor 901 is configured to determine a configuration parameter of a first measurement configuration and a scaling factor. The transmitter 902 is configured to notify a user equipment of the configuration parameter of the first measurement configuration and the scaling factor that are determined by the processor 901, so that the user equipment determines a configuration parameter of a second measurement configuration according to the configuration parameter of the first measurement configuration and the scaling factor, where the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

The processor 901 is configured to determine the configuration parameter of the first measurement configuration and determine the configuration parameter of the second measurement configuration or the scaling factor, where the scaling factor is used to determine the configuration parameter of the second measurement configuration, and the first measurement configuration makes it more difficult than the second measurement configuration for the neighboring cell to meet the reporting criterion of a handover measurement report.

The transmitter 902 is configured to notify the user equipment of the configuration parameter of the first measurement configuration and the configuration parameter of the second measurement configuration that are determined by the processor 901, or notify the user equipment of the configuration parameter of the first measurement configuration and the scaling factor that are determined by the processor 901.

In this embodiment of the present invention, a base station not only notifies a user equipment of a configuration parameter of a first measurement configuration, but also notifies the user equipment of a configuration parameter of a second measurement configuration or a scaling factor. The user equipment may determine the configuration parameter of the second measurement configuration by using the scaling factor. Therefore, when a timer used to detect a radio link failure starts, and a reporting criterion of a handover measurement report of the first measurement configuration is not met, the user equipment performs a measurement on a serving cell and a neighboring cell according to the second measurement configuration that has a more tolerant reporting criterion, so that the user equipment can select a proper cell in a timely manner, thereby effectively ensuring communication continuity of the user equipment.

The base station 900 can implement steps of the base stations mentioned in the methods in FIG. 1 to FIG. 4. To avoid repetition, details are not provided herein again.

Optionally, as an embodiment, the transmitter 902 is further configured to notify the user equipment of an identity used to distinguish the configuration parameter of the first measurement configuration from the configuration parameter of the second measurement configuration.

Optionally, as another embodiment, the base station 900 further includes a receiver 903, where the receiver 903 is configured to receive a measurement result sent by the user equipment. The transmitter 902 is further configured to send a handover request message to a base station of the neighboring cell according to the measurement result. Further, the transmitter 902 is further configured to send a handover command to the user equipment according to a handover request acknowledgment message sent by the base station of the neighboring cell.

Therefore, a success rate of a cell handover or radio link re-establishment is increased, so that a UE can be handed over to a cell of better signal quality in a timely manner, thereby ensuring communication continuity of the UE.

A communications system according to an embodiment of the present invention may include the foregoing user equipment 500/800 or the foregoing base station 600/900.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A mobility management method, comprising:
determining a first measurement configuration and a second measurement configuration, wherein the first measurement configuration makes it more difficult than the second measurement configuration for a neighboring cell to meet a reporting criterion of a handover measurement report;
performing a measurement on a serving cell and the neighboring cell according to the first measurement configuration; and
performing a measurement on the serving cell and the neighboring cell according to the second measurement configuration when a reporting criterion of a handover measurement report of the first measurement configuration is not met and a timer used to detect a radio link failure starts.

2. The method according to claim 1, wherein determining the first measurement configuration and the second measurement configuration comprises:
receiving a configuration parameter of the first measurement configuration and a configuration parameter of the second measurement configuration that are notified by a base station; and
receiving an identity that is notified by the base station and used to distinguish the configuration parameter of the first measurement configuration from the configuration parameter of the second measurement configuration.

3. The method according to claim 2, wherein a type of the configuration parameter of the first measurement configuration comprises at least one of the following: cell individual offset (CIO), a hysteresis, time to trigger (TTT), and offset; or
a type of the configuration parameter of the second measurement configuration comprises at least one of the following: cell individual offset (CIO), a hysteresis, time to trigger (TTT), and offset.

4. The method according to claim 1, wherein determining the first measurement configuration and the second measurement configuration comprises:
receiving a configuration parameter of the first measurement configuration and a scaling factor that are notified by a base station; and
determining a configuration parameter of the second measurement configuration according to the configuration parameter of the first measurement configuration and the scaling factor.

5. The method according to claim 1, wherein, after the performing the measurement, the method further comprises reporting a measurement result to a base station of the serving cell when a reporting criterion of a measurement report of the second measurement configuration is met, so that the base station of the serving cell sends a handover request message to a base station of the neighboring cell according to the measurement result.

6. The method according to claim 5, wherein the method further comprises sending a radio link re-establishment message to the base station of the neighboring cell when a radio link failure occurs.

7. A mobility management method, comprising:
determining a configuration parameter of a first measurement configuration and a configuration parameter of a second measurement configuration, wherein the first measurement configuration makes it more difficult than the second measurement configuration for a neighboring cell to meet a reporting criterion of a handover measurement report; and
notifying a user equipment of the configuration parameter of the first measurement configuration and the configuration parameter of the second measurement configuration, so that the user equipment performs a measurement on a serving cell and the neighboring cell according to the first measurement configuration, and performs a measurement on the serving cell and the neighboring cell according to the second measurement configuration when a reporting criterion of a handover measurement report of the first measurement configuration is not met and a timer used to detect a radio link failure starts; or
determining a configuration parameter of a first measurement configuration and a scaling factor; and
notifying a user equipment of the configuration parameter of the first measurement configuration and the scaling factor, so that the user equipment determines a configuration parameter of a second measurement configuration according to the configuration parameter of the first measurement configuration and the scaling factor, wherein the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

8. The method according to claim 7, wherein a type of the configuration parameter of the first measurement configuration comprises at least one of the following: cell individual offset (CIO), a hysteresis, time to trigger (TTT), and offset; or a type of the configuration parameter of the second measurement configuration comprises at least one of the following: cell individual offset (CIO), a hysteresis, time to trigger (TTT), and offset.

9. The method according to claim 7, wherein the method further comprises notifying the user equipment of an identity used to distinguish the configuration parameter of the first measurement configuration from the configuration parameter of the second measurement configuration.

10. The method according to claim 9, wherein the method further comprises:
receiving a measurement result sent by the user equipment; and
sending a handover request message to a base station of the neighboring cell according to the measurement result.

11. The method according to claim 10, wherein the method further comprises sending a handover command to the user equipment according to a handover request acknowledgment message sent by the base station of the neighboring cell.

12. A user equipment, comprising:
a processor; and
a computer-readable storage medium storing a program to be executed by the processor, the program including instruction to instruct the process to:
determine a first measurement configuration and a second measurement configuration, wherein the first measurement configuration makes it more difficult than the second measurement configuration for a neighboring cell to meet a reporting criterion of a handover measurement report; and
perform a measurement on a serving cell and the neighboring cell according to the first measurement configuration stored in a memory, wherein when a reporting criterion of a handover measurement report of the first measurement configuration is not met and a timer used to detect a radio link failure starts, the processor is further configured to perform a measurement on the serving cell and the neighboring cell according to the second measurement configuration stored in the memory.

13. The user equipment according to claim 12, wherein the user equipment further comprises a receiver, which is configured to receive a configuration parameter of the first measurement configuration and a configuration parameter of the second measurement configuration that are notified by a base station and to receive an identity that is notified by the base station and used to distinguish the configuration parameter of the first measurement configuration from the configuration parameter of the second measurement configuration.

14. The user equipment according to claim 13, wherein the receiver is specifically configured to receive a configuration parameter of the first measurement configuration and a scaling factor that are notified by a base station; and
wherein the program instructs the processor to determine a configuration parameter of the second measurement configuration according to the configuration parameter of the first measurement configuration and the scaling factor.

15. The user equipment according to claim 12, wherein the user equipment further comprises a transmitter, which is configured to report a measurement result to a base station of the serving cell when a reporting criterion of a measurement report of the second measurement configuration is met, so that the base station of the serving cell sends a handover request message to a base station of the neighboring cell according to the measurement result.

16. The user equipment according to claim 15, wherein the transmitter is further configured to send a radio link re-establishment message to the base station of the neighboring cell when a radio link failure occurs.

17. A base station, comprising:
a processor and a transmitter, wherein
the processor is configured to determine a configuration parameter of a first measurement configuration and a configuration parameter of a second measurement configuration, wherein the first measurement configuration makes it more difficult than the second measurement configuration for a neighboring cell to meet a reporting criterion of a handover measurement report; and
the transmitter is configured to notify a user equipment of the configuration parameter of the first measurement configuration and the configuration parameter of the second measurement configuration that are determined by the processor, so that the user equipment performs a measurement on a serving cell and the neighboring cell according to the first measurement configuration, and performs a measurement on the serving cell and the neighboring cell according to the second measurement configuration when a reporting criterion of a handover measurement report of the first measurement configuration is not met and a timer used to detect a radio link failure starts; or wherein
the processor is configured to determine a configuration parameter of a first measurement configuration and a scaling factor; and
the transmitter is configured to notify a user equipment of the configuration parameter of the first measurement configuration and the scaling factor that are determined by the processor, so that the user equipment determines a configuration parameter of a second measurement configuration according to the configuration parameter of the first measurement configuration and the scaling factor, wherein the first measurement configuration makes it more difficult than the second measurement configuration for a neighboring cell to meet a reporting criterion of a handover measurement report; performs a measurement on a serving cell and the neighboring cell according to the first measurement configuration; and performs a measurement on the serving cell and the neighboring cell according to the second measurement configuration when a reporting criterion of a handover measurement report of the first measurement configuration is not met and a timer used to detect a radio link failure starts.

18. The base station according to claim 17, wherein the transmitter is further configured to notify the user equipment of an identity used to distinguish the configuration parameter of the first measurement configuration from the configuration parameter of the second measurement configuration.

19. The base station according to claim 17, wherein the base station further comprises a receiver, configured to receive a measurement result sent by the user equipment; and
wherein the transmitter is further configured to send a handover request message to a base station of the neighboring cell according to the measurement result.

20. The base station according to claim 19, wherein the transmitter is further configured to send a handover command to the user equipment according to a handover request acknowledgment message sent by the base station of the neighboring cell.
